(19) United States
(12) Patent Application Publication
(10) Pub. No.: US 2005/0146607 A1
(43) Pub. Date: Jul. 7, 2005

(54) Object Approaching Detection Anti Blind e-Mirrors System

(75) Inventors: Romeo S. Linn, San Jose, CA (US); Raymond Spykerman, Mesa, AZ (US)

Correspondence Address: ROMEO S. LINN, 1933 O'TOOLE AVE., STE A206, SAN JOSE, CA, 95131, US

(73) Assignee: Romeo S. Linn, San Jose, CA (US)

(21) Appl. No.: 10/707,714

(22) Filed: Jan. 6, 2004

(51) Int. Cl. H04N 7/18

(52) U.S. Cl. 348/148; 348/143

(57) ABSTRACT

The e-Mirrors system promotes a new standard of driving safety views device, which upgrade regular glass mirrors from optical reflective to optoelectronic. The e-Mirrors system overcomes lots problems of conventional mirrors: blind spots, poor rear view, poor object approaching view etc. Variety new design vehicles made in the century 21 need higher standard safety view devices to drive in more & more crowded traffic system since population is growing rapidly. Time to change! Trend to go optoelectronic safety view. The e-Mirrors system integrates ultra night vision multi micro CCD cameras, high definition low distortion Lens, multiple mini LCD panels, New concept design camera mounts, video processor (or switch) all in 1. Each component apply unique design, each view setting has its technique. Using e-Mirrors to fill the absence of central rear mirror in trucks and buses large vehicles, drivers will be stress free. Driving everyday becomes easy, safely and fun! After tested in many vehicles, this e-Mirrors system proofs the most creative and the state of the art safety device since the invention of airbag. Its application will significantly reduce the traffic accidents causing by driver's “did not see it” error every year. Airbags now are legal mandatory devices for motor vehicles. However, airbags deploy to reduce lost of lives only after the collision, not able to reduce traffic accidents. Wish this handy e-mirrors system, cost less than airbags, be the second mandatory device for all vehicles soon!

### CROSS REFERENCE TO RELATED APPLICATIONS

This invention relates to create a new form of motor vehicle driving safety view device, called Object Approaching Detection Anti-Blind E-Mirrors System. This e-Mirrors system upgrades safety view mirrors from glass reflective type to optoelectronic type. Attempt to reduce traffic accidents every year, causing by driver's “did not see it” error.

### BACKGROUND OF INVENTION

Countless traffic accidents in the past related to insufficient safety views: Backing up at blind rear views then ran over children; Pull out from parking lot too quick and hit up coming vehicle or side walk people; Quick changing lanes on freeway without aware a hidden vehicle or motorcycle at the side; Tow truck sweep the trailer while passing over without seeing small vehicle at the side; Sharp braking on freeway to avoid something at front without seeing other vehicle following to close, then collisions happen. Because driver's “did not see it!”.

How can we let a driver see the back and the side clearly and let the driver view the proximity between any approaching object to your vehicle? So to avoid this type of driver's “did not see it!” traffic accident? The answer is Yes! our optoelectronic e-Mirrors which is cost less than those airbags in your car, but will be the most effective to your driving safety, so to lower your everyday driving risk, and let you stress free, have more fun on driving. Drivers will really miss it after your first try on it, no matter what type of vehicle. (See all 12 pages figures)

The senior inventor, Mr. Raymond Spykerman had foreseen the “Must Need” of car rear safety views electronic mirrors system many years ago. It should be mandatory use in any automobile in the future. After many years hard working, his dream coming true. we present it here to benefit to our society. He points out at follow that how this invention so handy useful, and how it benefits every driver like you:

Why do vehicles have a reverse gear when you can't see to back up.???

Be safe and see all behind you by looking forward.

Stop killing small children you can't when you back up.

Got a stiff neck, don't worry. Look forward and see back.

In a parking space with large vehicles beside you. Can't see before you back over half way out? Look forward and see back.

Back up safely by looking at the monitor in front of you.

Now you have eyes in the back of your head. Lucky you!

Anti-blind view camera's are needed more than air bags or seat belts.

you use them all the time. Not just in emergencies

Back up safely, change lane safely, No more guessing

Be a responsible driver. Don't back up blind. Don't change lane blind!

See all, know when it is safe to change lane or to back up.

Airbags and seat belts and are required. Most drivers never use them.

Rear view & side view cameras use all the time, airbags never deploy to good drivers

### SUMMARY OF INVENTION

The e-Mirrors system is integrated with night vision capable multi micro CCD cameras, high definition low distortion Lens, multiple mini LCD Panels, and creative concept design title-able camera mounts. Micro cameras are mounted on specific points to get the best proximity views of approaching object or vehicles. It creates safety views to clear off blinds spots areas that conventional reflective mirrors remain. The e-Mirrors system promotes new standard safety view device by upgrading optical to optoelectronic. The e-Mirrors system significantly enhances driving safety in more & more crowded traffic environment since the rapid growth of the population.

Each component of the e-Mirrors system applies unique design and techniques, such as full 180° rear view dual camera rear setting; license plate on frame stereo mount; High definition, low distortion; large iris high bright optical lens & super night vision; day & night high tolerant luminous auto-adjustment 6^{th} generation DSP driving chip; single panel multi screen LCD with rear/side view auto switch control; quick surface mounts without cutting or hurting any luxury cars finish; micro water proof micro camera housing; low air-drag mounts etc. All these lead it reaches the state of the art, matchless. After tested in many vehicles, The e-mirrors system is proof the most practical design for next generation vehicle driving safety device. It's more over the invention of airbag.

### BRIEF DESCRIPTION OF DRAWINGS

There are 12 pages of drawings and figures illustrated how the e-Mirrors system work.

Page title of drawings & figures

P1 Driver s Blind View Spots

P2 Driver's Other Blind Spots & Problems of Single Rear View Camera

P3 Optoelectronic CCD Cameras Eyes & Lens

P4 On Dashboard Mount Dual LCD Screen e-Mirrors

P5. License Plate L-R Stereo Mount Camera Technique

P6. Dual Cameras Rear Object Detection Technique

P7. Better Proximity Detection Rear Corner Mount Technique

P8. Object Approaching Detection At Blind Spot

P9. Front Corner Hood Edge Side Mount Technique

P10. Truck & Bus e-Mirrors Setting

P11. Panoramic High Safety Views for Mission Vehicles

P12. Multi-Cameras, LCD e-Mirrors & Quad Video Processor Configurations

The inventor, Romeo Linn, tries to illustrate as details as possible by using photos, CAD drawing and VR 3D rendering. If you are interested in more information of the e-Mirrors system, and want to see all color pictures, please check www.CenturyInventions.com.

### DETAILED DESCRIPTION

Countless traffic accidents related to the driver's “Did not see it !” errors, because of the blind spots existing in all regular glass reflective mirrors. It's time to find out what problems and shortages in conventional 40 years old optical reflective mirrors.
1) Glass reflective character make it narrow viewing angles. no way to eliminate side blind spots
2) Glass mirrors are not flexible to mounts anywhere of the vehicle, But only driver's front visible field. No mirror mounted in the back
3) Mirror can not be mounted more than 6 feet away from the driver. Or image would be too small to make attention.
4) Mirrors are NOT able to reflect the proximity view of an approaching vehicle (or sidewalk people, or other objects) away from your vehicle. (see P1, P2 figures)

Even though some convex type of side mirrors can be used to reflect the driver's blind spot, however the passenger side mirror image is too small and too far away from driver to make him pay attention.

Optical reflective mirrors are no way to eliminate all these problem, and are obviously not able to meet the need of higher standard driving safety view for all motor vehicles driving in more and more crowded traffic routes system due to the rapid growth of population. What is more? Massive diversity design large motor vehicles are made in the millennium new century. They need better safety view mirrors. No need to mention the need of mission vehicles for higher standard panoramic safety views.

Time to create better driving safety view using different method!

Thanks for the technology development of small high resolution color LCD display. And the evolution of high performance micro CCD cameras. They are all available and affordable in the resent 3 years. (compare to over 60 years automobile history). This makes optoelectronic e-vision technology for driving safety possible, and affordable!

Before we go into detail of the e-Mirrors system, let's see some existing safety view optoelectronic devices. They usually apply single camera+single display configuration. Will check if this type of devices work well?

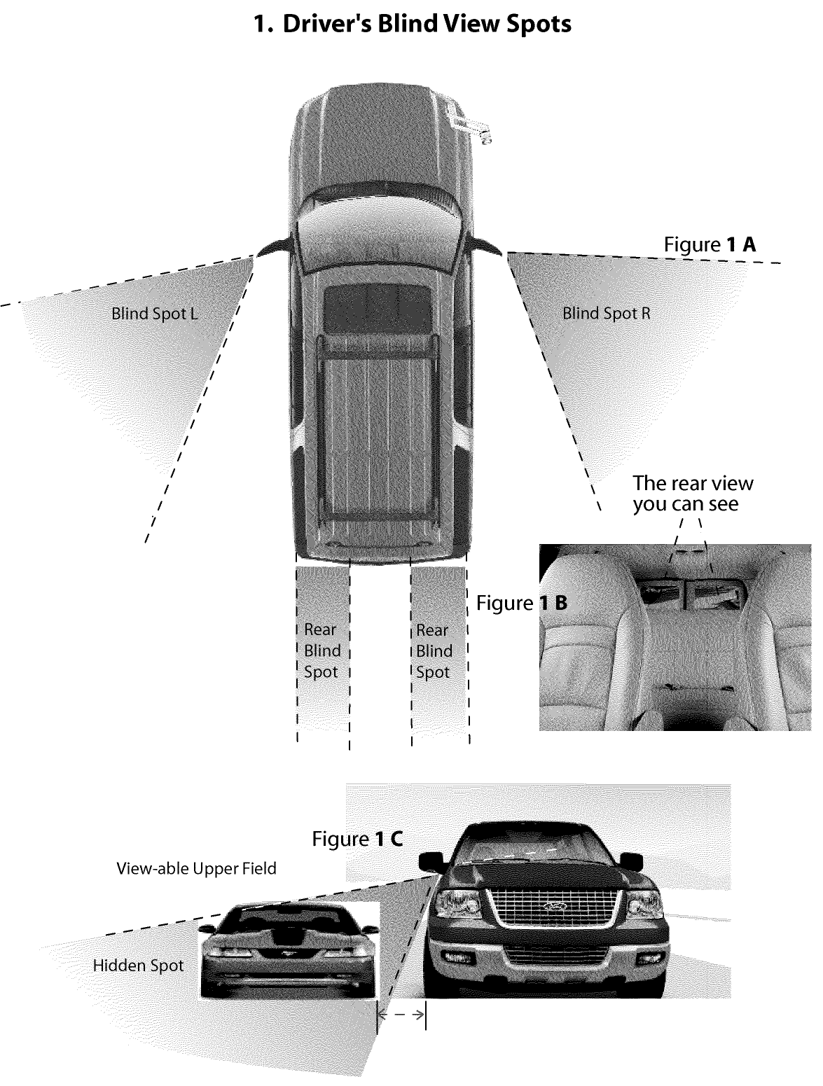

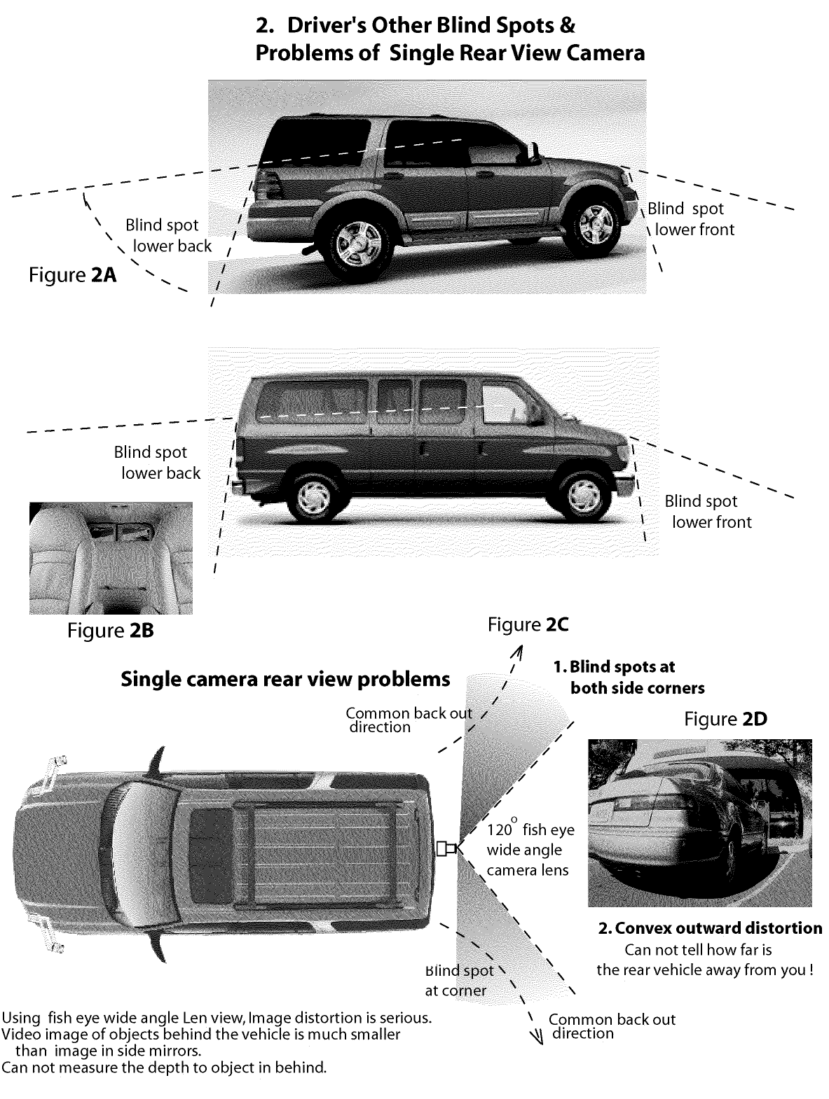

A typical single rear view camera safety view device. (see P2 FIGS. 2C, 2D)
1) There are still blind spot at both side corners.
2) Using fish eye lens camera to cover the whole rear view field. Heavy convex outward distortion happen.
3) Fish eye lens shrink the rear vehicle image size too small to match with size of images in side mirrors or center mirror.
4) Single camera shows straight back view. Not able to view the proximity. Driver still need to guess the proximity to avoid hitting a rear object.

Conclusion: Single rear view camera and display setting doest not do the exact jobs that we want.

Introduction to a new standard driving safety view e-Mirrors system using multiple optoelectronic is. It integrates with night vision capable multi micro CCD cameras+high definition low distortion board Lens+high resolution multi-small LCD panels+angle title-able special design camera mounts all together. The detail of this device has been illustrated in the 12 pages of figures. (please skim all 12 pages figures)

So far, almost all of large vehicles, like container trucks, tow trucks, gas tank tow truck and buses are not able to view the back due to no center rear mirror. Large vehicle drivers have high stress to operate their truck. Driving is not fun.

The e-Mirrors system revolutionary enhance the viewing capability for motor vehicles driving safety, cause able to view the proximity of approaching vehicle. With this e-mirrors system, drivers get “more eyes on their head”. A blind handicap personal has a safety pressure to walk across a traffic intersection, but a normal good vision person just feel free to walk across the risky intersection. So do drivers, they will be stress free while “more eyes on their head”. No more blind driving, nor guessing driving. They will feel driving more fun and relax.

With the help of this e-Mirrors system, traffic accidents, causing by “did not see it” error, will be significantly reduced. The total lost of lives and properties will be significantly reduced. It's deserve to say: “This is more over the invention of airbag!” since airbag is the last chance to save life after the collision. But it dose not prevent or to reduce traffic accident chances. It reduce only the lost of lives after. Airbags never deploy unless deadly accident happen. Good drivers will never see it open, but still pay it for big $.

Nowadays, airbag is set as legal device for all vehicles. When this handy e-mirrors system can be a second legal safety device for all vehicles?

1. The Object Approaching Safety View Anti-Blind e-Mirrors System promotes a new method of driving safety view for motor vehicles from optical type to optoelectronic type. This new method meet the need of higher safety view standard for more & more crowded traffic system in the future due to the rapid growth of population. (Please go through all 12 pages of figures first). It fills out also the blank of all large trucks and buses missing the center rear mirror.

2. The integration of The e-Mirrors system. It's integrated with night vision capable multi micro CCD cameras+high definition low distortion board Lens+high resolution multi-small LCD panels+angle title-able special design camera mounts. (skim all P12 figures) The cameras are mounted on specific corner points, so to get perfect views to detect any object or vehicles around approaching to your vehicle. (see P8, P7 figures)

3. Overcome all blind spots any other problems found in regular optical mirrors (see section Detailed Description) and a lot more. The e-mirrors system not only overcome all blind spots of 40 years old conventional optical mirrors, but also extend driver's eyes to view the rear surround the vehicle, get the proximity view of any vehicle or object approaching to your vehicle, more over regular optical mirrors that reflects only deepness and size.

4. Avoid, and react earlier concept. With this object approaching proximity view-able e-Mirrors system, any approaching object around your vehicle can be found, and driver can have enough second to react earlier to avoid collision. The e-Mirrors system will significantly reduce traffic accidents each year if to apply earlier.

5. e-Mirrors side by side dual screen for small vehicles. A pair of flat panel high resolution 5″ to 5.6″ LCD screens (around similar size of optical side mirrors), with synchronized brightness and contrast control, is mounted on dashboard near to center. The e-Mirrors will be set in same view direction with passenger side mirror. (see P4 figures).

6. e-Mirrors for large vehicles using quad display. For large vehicles, like container tow trucks, gas tank tow trucks, school buses, public buses etc, A large e-mirror is made with 8.4″ to 15″ inch size single video LCD panel (similar size of their side mirrors), is mounted on front dash near to passenger tool box for drivers rapid view. The e-Mirror is connected with 4 channel quad split video processor to present all blind spots around the large vehicle. The e-mirror can also be made with 2×2 array of small LCD screens. (see P10, P11 figures)

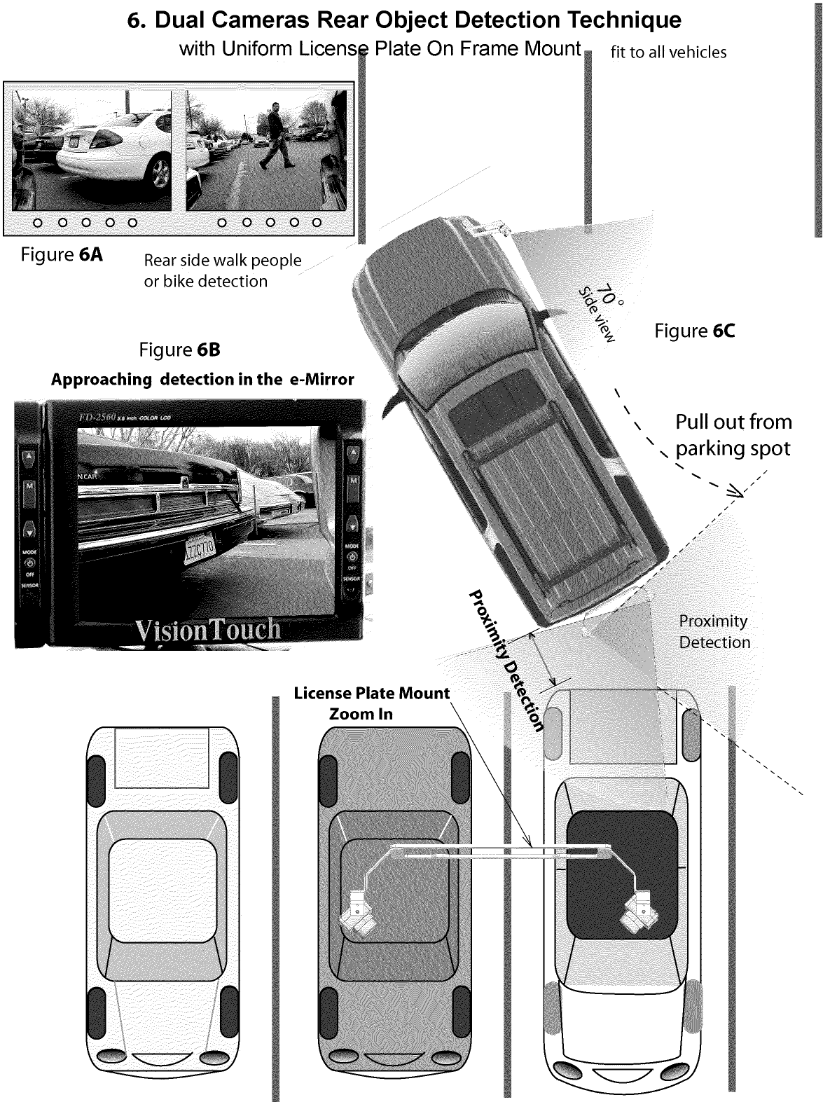

7. Dual micro CCD cameras apply for rear views setting to cover 180 degree full rear vision. (see FIG. 6A) This setting get 4 benefits:
1) Dual setting eliminates the blind spots at both side found in some single camera rear view system. (see FIG. 2C)
2) Dual cameras setting is also minimize the super wide angle distortion found in single camera setting, which shrinks the rear object to tiny image and difficult to estimate the proximity of a back vehicle or object.
3) Dual cameras setting enhance video definition since using reduce wide angle of lens. In optical theory, wide angle is conflict to definition.
4) Dual Camera will cover the whole 180 degree of view (90°×2), single camera will never reach that angle.

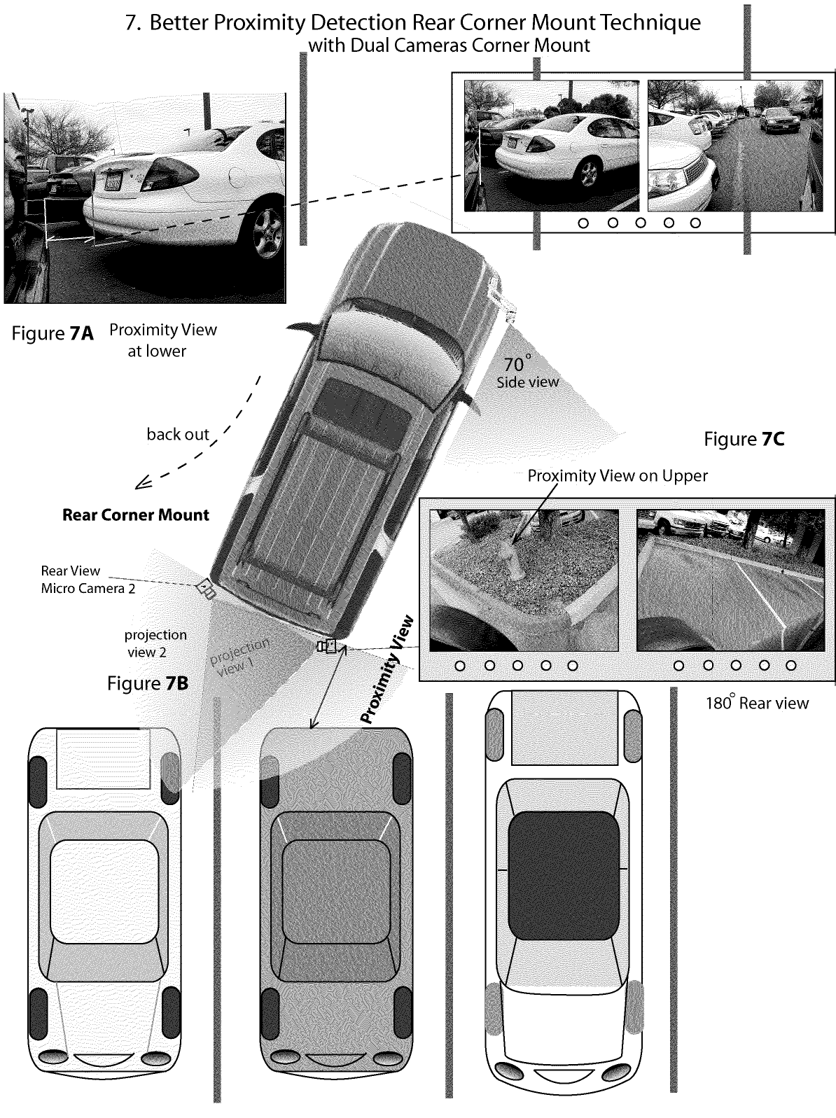

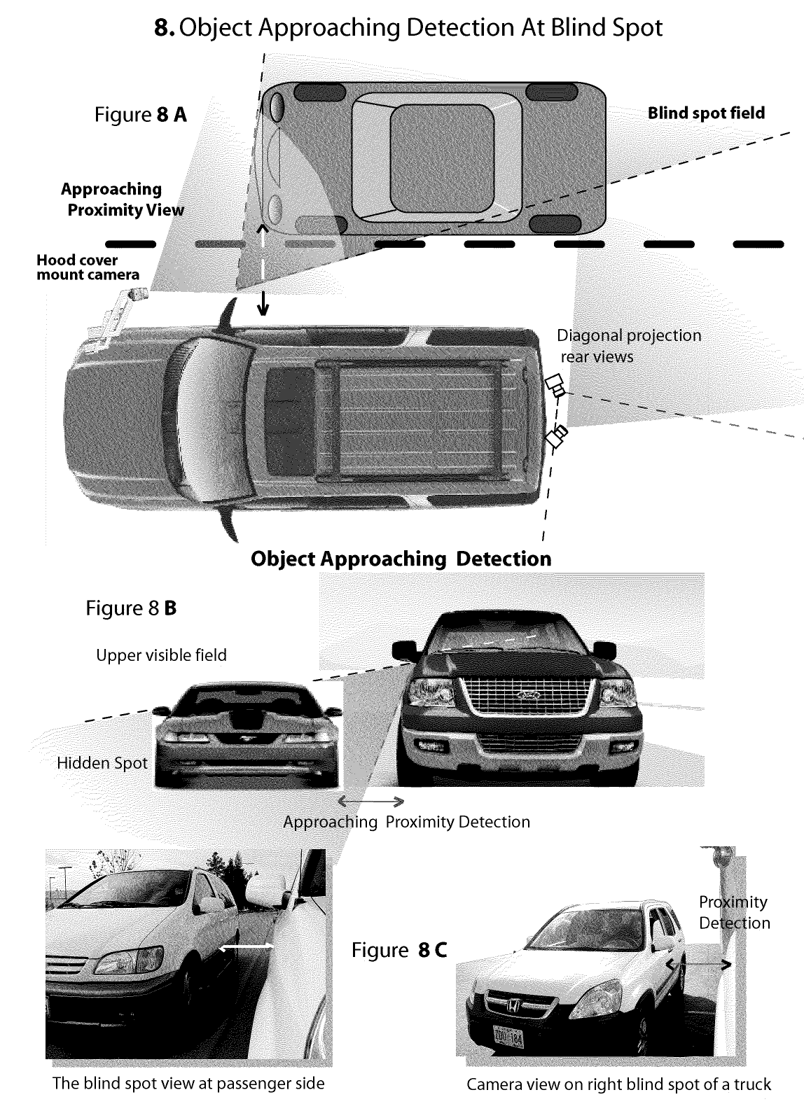

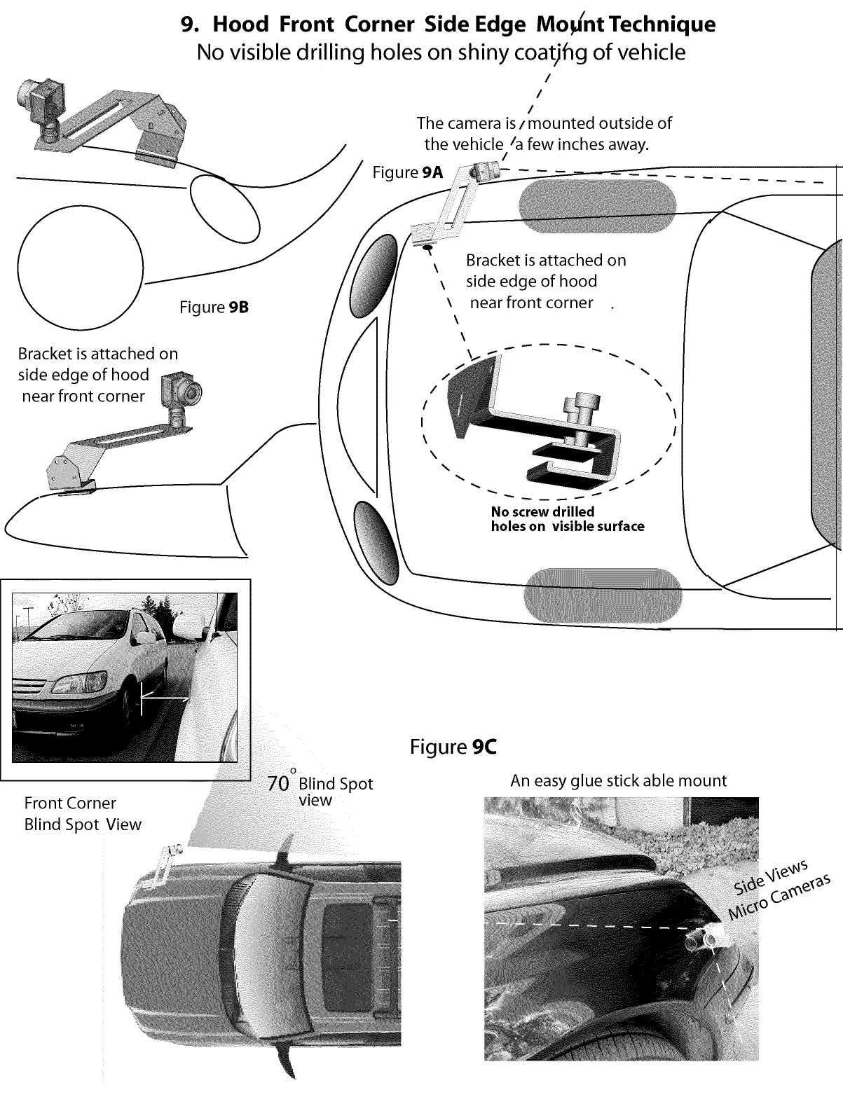

8. Object approaching detection anti side blind spot technique. To make it possible, a camera must be mounted out of front corner of vehicle a few inches using a short bar like bracket at passenger side. It's mounted like side mirrors. (see P8, P9, FIG. 9A)

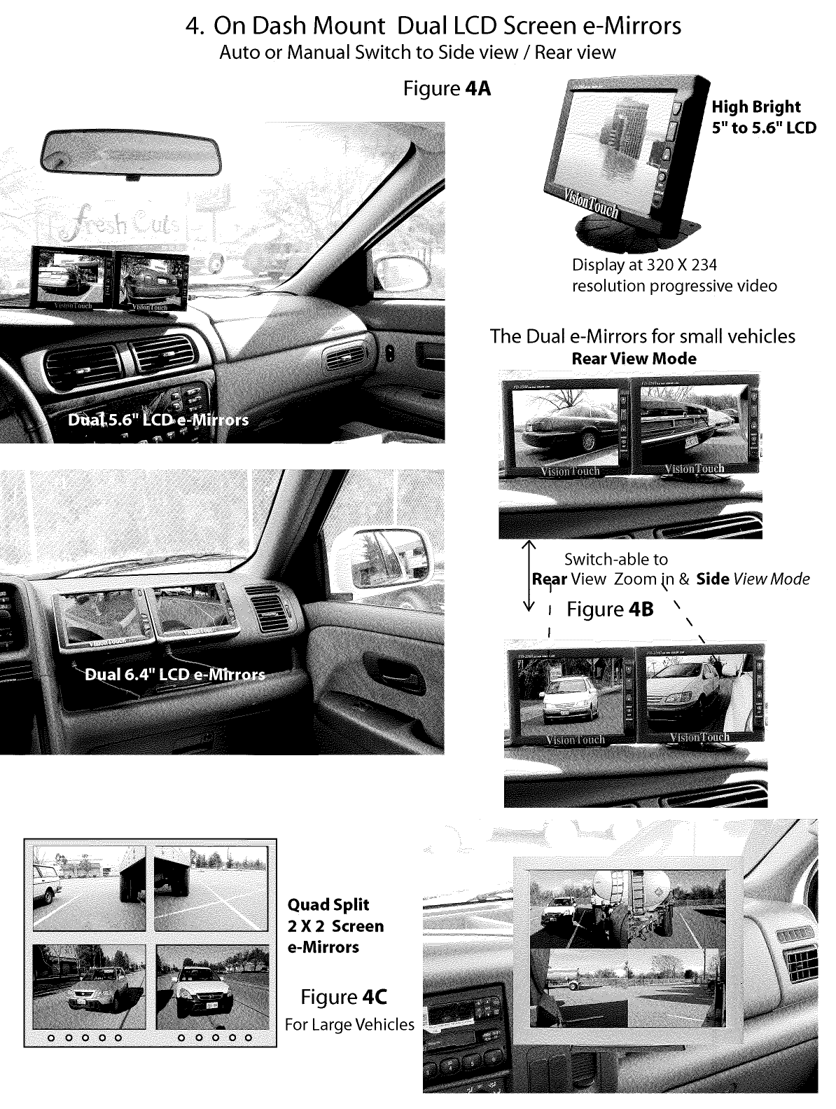

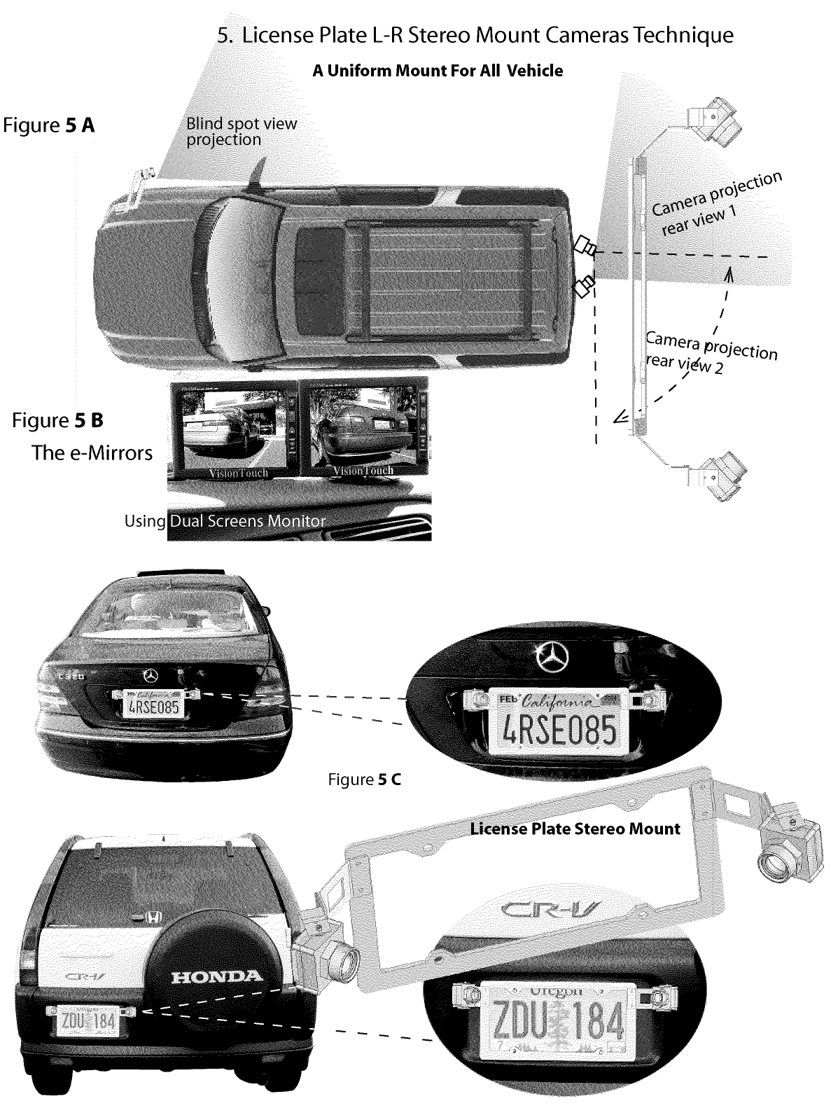

9. Rear cameras license plate on frame L-R stereo mounts with wide angle tilt-able mechanism. (see FIG. 5C, P6 figures). The angle tilt-able mechanism will be critical to large truck drivers. Since large trucks do not have center mirror. They need narrow angle 60 degree dual rear cameras and need to tilt the cameras screen viewing the rear corners when backing out.

10. Rear cameras license plate stereo mounts can apply to any automobiles without drilling screw holes nor modification to the shiny finish coating of vehicle. This feature will receive great welcome to owners driving luxury cars like Mercedes Benz, Porsche, Lexus, BMW etc.

11. Rear object proximity detection anti rear blind spot corner mount technique. When pulling a vehicle out of a parking spot. The turn corner of your vehicle will be heading out first. (figures P6). The best setting to view proximity is as figures P7. Left camera views right, right camera views left. However, that setting will be high cost to mount CCD cameras on rear corners of a new vehicle. This technique is good for new design vehicle, factories can pre-mount camera inside the tail lights, or brake lights

12. Rear object proximity detection license plate mount technique. License plate on frame dual cameras stereo mount is the most easy and uniform mount to all vehicles. (see P6 figures). This method is perfect good for luxury vehicle. since the installation does not need to drill holes nor to modify the car shiny finish coating. (see FIG. 5C) Another goodness to this mount is the easy power supply from license plate light to cameras.

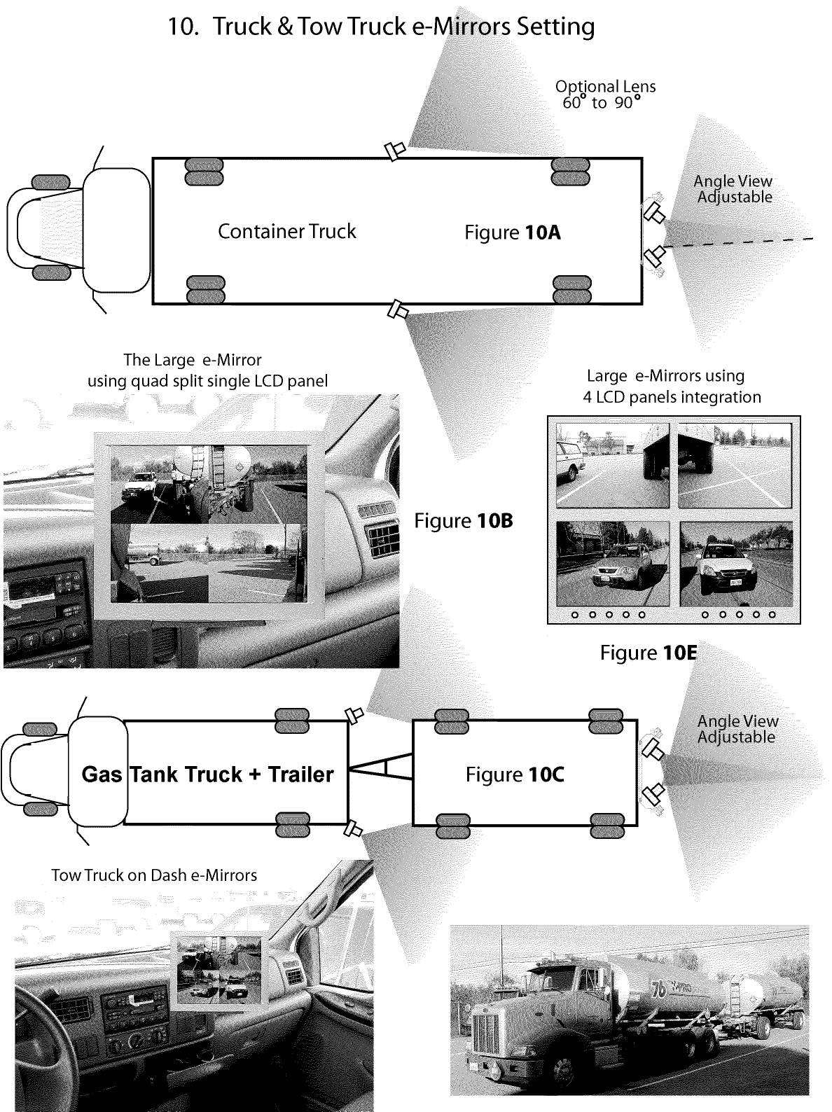

13. License plate dual rear cameras mount angle view adjustable to large vehicles without central rear mirror, like truck, tow truck, bus etc. Camera Lens 65 to 90 degree options. So to match with image size of optical side mirrors. If 65 narrow angle lens are applied, when backing out a truck, driver can adjust the dual rear cameras viewing on rear corners to get proximity view. Single driver can back out a large tow truck safely. After the back out operation, cameras angle can be adjusted to straight back. (see FIG. 10C)

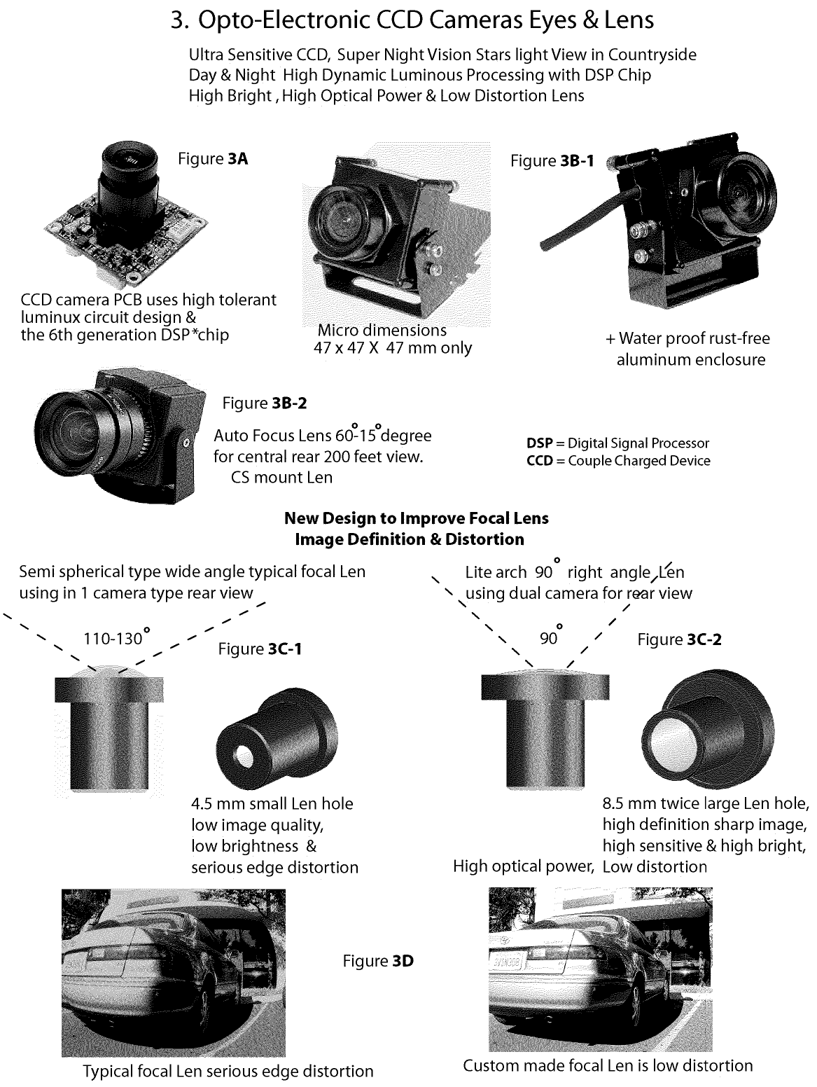

14. Super night vision, high Signal/Noise ratio, Day & night ultra dynamic auto compensation outdoor CCD custom design camera. (see P3 figures)
1) Super night vision for countryside driving. The cameras can view objects surround the vehicle at suburban dark night without road lights, nor city light, near human eyes invisible threshold. The super sensitive CCD chip and special design large iris lens make it possible.
2) High Signal/Noise ratio (52-to-60 db). It's the highest ratio in the market comparing to regular 40- to 48 db) The latest 6^{th} generation DSP (Digital Super Processor) chip make it possible.
3) Day & night ultra dynamic auto compensation outdoor usage without blur video effect. The cameras can “see” under high beat head light or under sunlight without showing burning video effect. Under dark environment, you don't see heavy snow noise on the e-Mirrors. The latest generation DSP (Digital Super Processor) chip and highest tolerant special circuit design make it possible. (P3 figures)
4) Using micro water proof enclosure for vehicle external use. (FIG. 3B)

15. Special design of micro board lens: super large iris and, 90 degree right angle, ultra low distortion, high resolution. so to eliminate typical focal Len serious convex distortion, best meet to the requirement of rear view cameras. (FIG. 3C) Thanks to the support of a China optical component factory. They gave us a great insight when we design the new curve optical lens with more glass layers combination.
1) Using finger nail size micro board lens, instead of large diameter regular indoor CS mount lens for vehicle use cameras. Nevertheless, all optical performances in our new design board lens are even better than large size CS mount lens, when the total size is only ⅙ of CS lens
2) Super large optical iris. 8.5 mm-to-9 mm diameter compare to regular 4 or 4.5 mm board lens iris. That ultra iris make it possible for maximum light throughput and high optical power, so to produce the super sharp video image and highest definition. This advantage makes the video image 4-5 times brighter than regular board lens l the market.
3) Large object Lens to minimize convex distortion image while keeping 90 degree wide angle view lens. (figure 3C-2, 3D). Drivers often criticize problems found in some single rear view camera: shrinking image, heavy convex distortion image. blur image, fuzzy video etc. You don't see those problem again in our unique design Lens.
4) Dual 90 degree horizontal right angle Lens, (not wider than 95 degree each) best cover 180 degree rear view, and show rear objects size to match with image size in regular reflective rear mirror. Control the convex distortion under 9% (regular lens are 25%-30% distortion)
Never think an indoor camera can work for a car in outdoor day & night full weather requirement.

16. Camera mounts for large motor vehicles, like container truck, trailer tow truck, gas tank tow truck, school bus, and public bus etc. The configuration will use 4 cameras, 2 on middle of the body, other 2 on the rear corners or on the license plate L-R. see P10 figures.

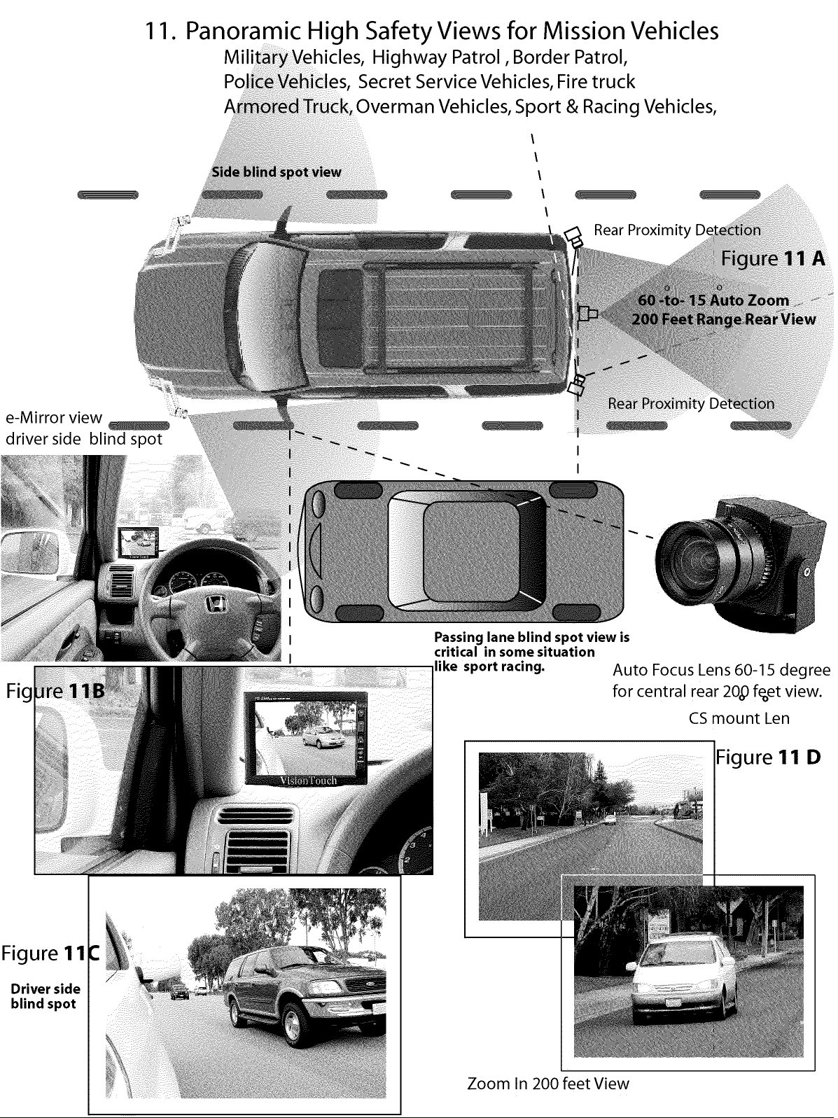

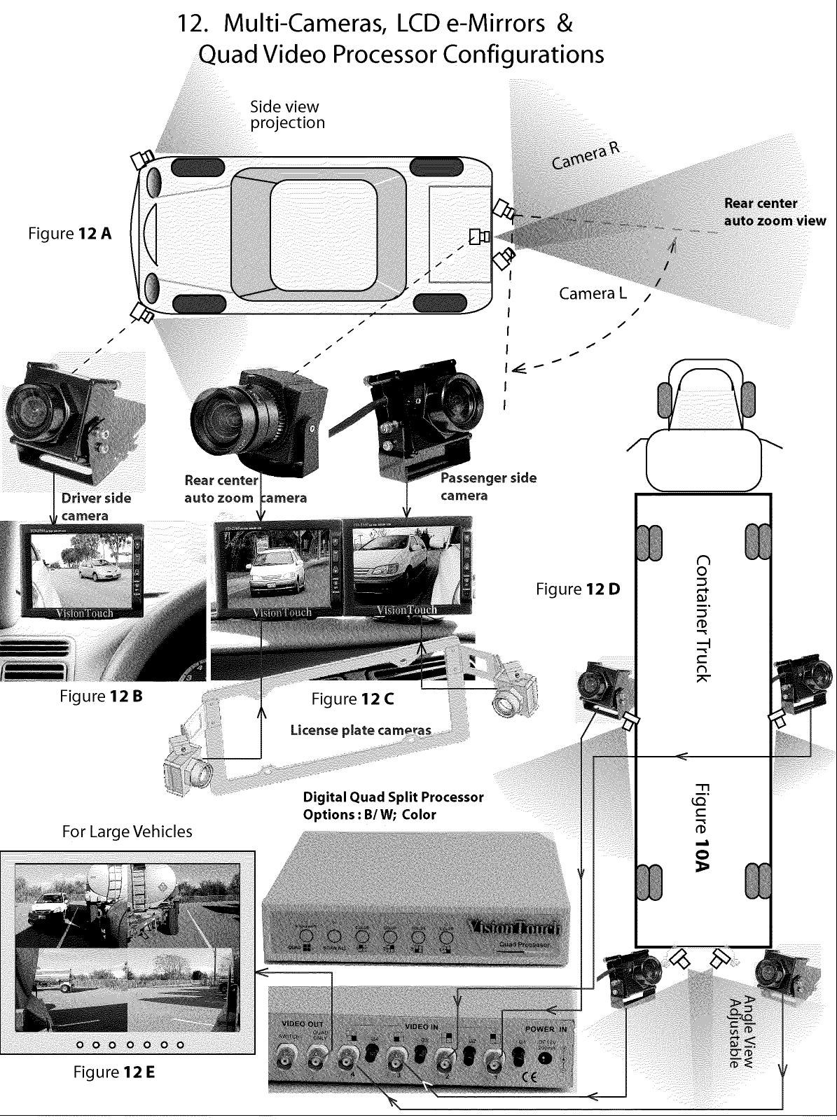

17. Panoramic Safety View Anti-Blind e-Mirrors System for Mission Vehicles. This system apply 5 cameras to create panoramic view for mission vehicles. A blind spot view camera in driver side is applied (see FIGS. 11B, 12B). Its LCD e-Mirror setting is a bit challenge. It can not set at central with the right e-Mirror. The best setting point is on dashboard left corner, so to get the same view direction of outdoor left mirror.

18. Center rear view auto zoom camera for mission vehicles. This is the 5th camera. (see FIG. 11A) It use auto-focus lens adjustable from 60-to-15 degree. (see FIG. 11D) It can view any following vehicles behind you and can zoom in like telescope. The center rear auto zoom camera is mounted inside the rear wind shield or is hided inside of the vehicle. Meanwhile, a switch control will let driver switch (views when display 4 cameras view on dual screen e-mirror. (See FIG. 12C) Panoramic View Anti-Blind e-Mirrors System for Mission Vehicles is best for military vehicles, highway patrol, border patrols, police vehicles, secret service vehicles, fire truck, armored truck, government vehicles, sport & racing vehicles etc.

19. e-Mirrors as part of rapid view instruments for spot racing vehicles. (see FIGS. 11B, 12B, 12C) The driver side blind spot e-Mirror is best for sport racing vehicles. Since racing cars usually pass from left side. Rapid viewing (glancing) left side blind spot without turning driver's head away from forward view is critical to racing drivers. Racing drivers always be caution when any racing car attempt to pass him. Driver is in high tension at super racing speed. He dose not even have chance to turn his head left when racing in 120 mph such super speed. Racing vehicle will run over 171 feet in just 1 second. That distance is enough to hit other vehicles at front or to hit road side and flip over (then crash). In such “no head turn allow” critical situation, glancing on the left e-Mirror checking the blind spot will be super advantage to those racing drivers. For future spot vehicles design, the left e-Mirror can integrate with dash board design and near to the engine speed meter. That combination can call rapid view instruments for racing driver.

20. e-Mirrors multiple configurations for variety vehicles at different safety view level.
1) For small vehicles, connection is as FIG. 12C
2) For mission vehicles, will add on configuration FIGS. 12B, 12C.
3) For large vehicles, connection will combine digital quad video processor. See FIG. 12E.
4) For tow trucks, beside the 3), rear cameras might apply video boosters since they are 50 feet away from the e-mirror on dashboard. It depend on the coaxial video cables grade, and the trailer length.

21. Vehicle hood front corner side edge mount technique. No visible drilling holes on shiny coating of vehicle. (see FIGS. 9A, 9B) This technique is very good for existing luxury cars and SUV. For new design car, factory can pre-make a mount space and bracket at the front corner for anti blind camera.

22. Aerodynamic design and 3 dimensional title-able bracket for front camera, avoids unnecessary airflow turbulence at high speed. Flexible angle mount will fit cars and vans different sloping angle hood. (see FIG. 9B)
